(19) United States
(12) Patent Application Publication
(10) Pub. No.: US 2024/0143293 A1
(43) Pub. Date: May 2, 2024

(54) REUSING AND RECOMMENDING USER INTERFACE (UI) CONTENTS BASED ON SEMANTIC INFORMATION

(71) Applicant: VMware, Inc., Palo Alto, CA (US)

(72) Inventors: Rongbo PENG, Atlanta, GA (US); Zhen Jim PENG, Palo Alto, CA (US); Yina SONG, Beijing (CN); Zhilin FANG, Atlanta, GA (US)

(73) Assignee: VMware, Inc., Palo Alto, CA (US)

(21) Appl. No.: 17/974,563

(22) Filed: Oct. 27, 2022

(51) Int. Cl. G06F 8/38; G06F 8/36; G06F 40/30

(52) U.S. Cl. CPC G06F 8/38; G06F 8/36; G06F 40/30

(57) ABSTRACT

A recommendation system reuses user interface (UI) strings in a virtualized computing environment based on semantic information. The recommendation system receives an input UI string query, and searches indexed and validated UI strings for candidate UI strings. The candidate UI strings are identified based on a relevance score and then ranked based on a semantic similarity score. The ranked UI strings are provided as a recommendation for a UI string in UI content of a user interface.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources in a virtualized computing environment may include central processing unit (CPU) resources, memory resources, storage resources, network resources, etc.

Such virtualization platforms enable end users, developers, product managers, system administrators, and other entities/users to access and operate various application, tools, services, and other features/functionality that are provided by the virtualization platforms. User interfaces (UIs) may be made available to these entities/users to facilitate their use/access of such features/functionality of the virtualization platforms. In many situations, these entities/users may create and/or customize the content of the UIs, rather than or in addition to the standardized/default content that is present in UIs that are provided for the virtualization platform (e.g., UI and UI content that were provided by the manufacturer or provider of the virtualization platform).

However, developers, product managers, and other entities that are tasked with creating UI content may not be aware of quality standards for UI content, localization best practices for UI content, and opportunities to reuse existing strings (e.g., text strings) that are available from a centralized system of the manufacturer or provider of the virtualization platform. As a result, the UI content (e.g., UI strings) that has been customized or otherwise created by these entities may suffer from misspellings, poor grammar, awkward phrasing, duplication, etc. relative to the existing strings from the manufacturer/provider.

### BRIEF DESCRIPTION OF DRAWINGS

FIG. 1 is a schematic diagram illustrating an example computing environment that can implement user interface (UI) content recommendation techniques;

FIG. 2 is a schematic diagram illustrating an example architecture for a recommendation system implemented in the computing environment of FIG. 1;

FIG. 3 is a schematic diagram illustrating example collection, validation, and index and search features for the recommendation system of FIG. 2;

FIG. 4 is a flow diagram of an example method to resolve input UI string queries; and

FIG. 5 is a flowchart of an example method to reuse UI strings based on semantic information.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses the above and other drawbacks associated with providing UI content for user interfaces. First and according to various embodiments, current UI strings are converted into or otherwise used as validated UI strings stored in a UI string pool. The UI string pool may be shared with subscribing users who are attempting to create/develop UI content. This validation and sharing enable the subsequent reuse of the validated UI strings, as opposed to newly created UI strings by users that may contain issues such as nonuniformity, misspellings, grammar errors, etc. The UI string pool may be gradually purified/updated over time, thereby improving the quality of the UI strings. Through continuous monitoring of the UI strings in the UI string pool, the updating may be self-adaptive without manual intervention.

Furthermore through the validation, syntax or grammar issues can be eliminated, and the language styles across products can be kept consistent. Translation resources can also be leveraged, so as to reduce inconsistencies and errors in the UI strings.

Through the regular UI string verification/validation, statistics and analysis of UI string issues can be obtained and provided in a verification report. A developer team can subscribe to the verification report, so as to make timely modifications to their UI strings based on the content of the verification report.

Next and according to various embodiments, a recommendation system having a recommendation service is provided. The recommendation system may receive (from a user) an input query having a UI string or a few keywords as input, and may return a list of candidate UI strings. The UI string in the input query need not be a complete sentence, and can instead contain some keywords. The recommendation system may complete the input query based on the context, and perform a search against the validated UI strings in the UI string pool.

Conventional sentence encoders have a shortcoming: the execution time of a large corpus is long. In a production recommendation system, it is impractical to use sentence embedding on a large corpus, since a recommendation system should return recommendations in a few seconds or less. Therefore, the embodiments of the recommendation system described herein implement a hybrid approach, in which the input query is resolved by first retrieving a list of recommendation candidates, and then by re-ranking that list based the vector similarity (semantic similarity) between each candidate UI string in the list and the UI string in the input query.

Computing Environment

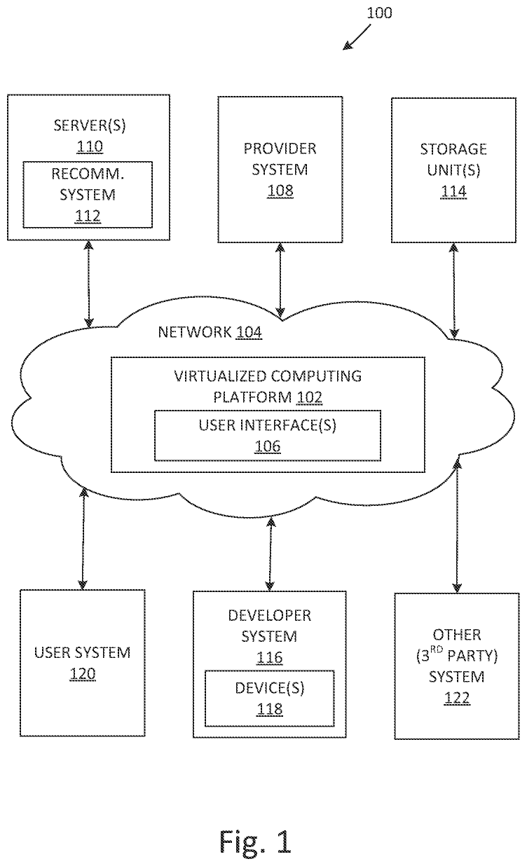

To further explain the details of semantic-based UI content recommendation (including reusing UI content), reference is first made herein to FIG. 1, which is a schematic diagram an example computing environment 100 that can implement UI content recommendation techniques. Depending on the desired implementation, computing environment 100 may include additional and/or alternative components than that shown in FIG. 1.

In the example in FIG. 1, the computing environment 100 includes a virtualized computing platform 102 that may be implemented in and/or accessible via a network 104. Among other things, virtualized computing platform 102 may comprise any number of interconnected hosts (also known as computing devices, host computers, host devices, physical servers, server systems, physical machines, etc.), wherein each host may be supporting tens or hundreds of virtualized computing instances, such as virtual machines (VMs).

Each host includes suitable hardware and virtualization software (e.g., a hypervisor) to support various VMs. A VM may in turn include a guest operating system (OS) and one or more guest applications (and their corresponding processes) that run on top of the guest OS.

A hypervisor may be a software layer or component that supports the execution of multiple virtualized computing instances. The hypervisor may run on top of a host operating system of a host or may run directly on hardware of the host. The hypervisor maintains a mapping between underlying hardware of the host and virtual resources allocated to VMs running on the host.

Hardware of a host in turn may include suitable physical components, such as central processing unit(s) (CPU(s)) or processor(s); storage device(s); and other hardware such as physical network interface controllers (NICs), storage disk(s) accessible via storage controller(s), etc. Virtual resources (e.g., virtual hardware) are allocated to each virtual machine to support a guest OS and application(s) in the virtual machine. Corresponding to the hardware of the host, such virtual hardware may include a virtual CPU, a virtual memory, a virtual disk, a virtual network interface controller (VNIC), etc.

Virtualized computing platform 102 may be used for or otherwise provide various functionalities/implementations (e.g., services and infrastructure). As one example implementation, virtualized computing platform 102 may provide a hyperconverged infrastructure (HCI) in which a software-defined system combines all of the elements of a data center: storage, compute, networking, and management. Virtualized computing platform 102 may also provide a virtual desktop infrastructure (VDI) implementation, wherein VMs are used to provide and manage remote/virtual desktops along with printer functionality. As still another example, virtualized computing platform 102 may provide a distributed storage system, such as a software-defined approach that virtualizes the local physical storage resources of each of the hosts and turns the storage resources into pools of storage. As yet another example, virtualized computing platform 102 may provide remote desktops for a virtual desktop infrastructure (VDI) environment. These are but a few example implementations of virtualized computing platform 102, and other types of implementations are possible.

A plurality of user interfaces (UIs) 106 may be provided in or for virtualized computing platform 102. Such UIs 106 may be used in connection with one or more of: accessing and using various functionalities and features (such as VMs and applications) of virtualized computing platform 102, managing (e.g., configuring, allocating, troubleshooting, updating, etc.) the hardware and software resources in virtualized computing platform 102; developing and designing features and functionality for virtualized computing platform 102; security and maintenance; and/or other purposes.

UIs 106 may present UI content, such as text, graphics, audio, etc. As an example, a UI may present a login screen or a welcome page with text content that prompts the user for a username and password. As another example, a UI may provide text content of a legal notice, operating instructions for an application, configuration instructions presented to a system administrator, prompts, etc. These are just some possible examples of the types of UIs 106 and corresponding UI content that may be provided in or for virtualized computing platform 102. UI content such as text content may be words, sentences, paragraphs, pages, etc. that are represented in the form of UI strings (e.g., text strings). Techniques for providing recommendations for such UI content, for implementing in UIs that are being developed, will be described in further detail later below.

A provider system 108 may manage or operate the infrastructure and/or services provided by the virtualized computing platform 102. For example, the provider system 108 may provide and maintain computing devices and related hardware/software to enable virtualized computing platform 102, and deliver services and other products to consumers (e.g., users and customers) of virtualized computing platform 102. An example of an entity corresponding to the provider system 108 is VMware™, Inc. of Palo Alto, California.

The provider system 108 may include or may be otherwise coupled to one or more computing devices, such as one or more servers that may reside within or outside of virtualized computing platform 102. For example, one or more management servers 110 can take the form of a physical computer with functionality to manage or otherwise control the operation of hosts, VMs, etc. in virtualized computing platform 102. In some embodiments, the functionality of the management server 110 can be implemented in a virtual appliance within virtualized computing platform 102, for example in the form of a single-purpose VM that may be run on one of the hosts in a cluster or on a host that is not in the cluster.

According to some embodiments, at least some components of a UI content recommendation system 112 may reside in the management server 110. In some embodiments, the components of the recommendation system 112 may reside at other locations/devices in the computing environment 100, alternatively or in addition to the management server 110, including distributed arrangements at a plurality of locations/devices. Users of the virtualized computing platform 102 may subscribe to the recommendation system 112 in some embodiments.

The provider system 108 may include or may be otherwise coupled to one or more storage units 114 that may reside within or outside of virtualized computing platform 102. According to one embodiment, the storage unit(s) 114 may provide a repository for standardized or other template-type UI strings (e.g., UI string pools), including UI strings that have been adapted over time and are made available for reuse. The storage unit(s) 114 may also store code or other information or data related to UIs 106 and their corresponding UI content. The recommendation system 112 may communicate with the storage unit(s) 114 and/or the storage unit(s) 114 may form part of the recommendation system 114. Further details of the recommendation system 112 and its use of UI content and other information stored in the storage unit(s) 114 will be described later below.

In addition to the provider system 108, the computing environment 100 may include other systems. For example, one or more developer systems 116 may develop and provide at least some of the features and functionalities (including the UIs 106) of virtualized computing platform 102. The developer system 116 may include computing device(s) 118 usable by developer team members (including system administrators) to create, modify, test, etc. the UIs 106. The computing device(s) 118 may communicate with the recommendation system 112 of the provider system 108, and may contain/run some components of the recommendation system 112 itself in some embodiments.

While the computing device(s) 118 are depicted in FIG. 1 as residing in the developer system 116, it is understood that this depiction is merely illustrative for purposes of simplicity. The computing devices 118 and their functionality described herein pertaining to UI content recommendation may be implemented in any of the systems of the computing environment 100 shown in FIG. 1.

The computing environment 100 may include still other systems, such as a user system 120. The user system 120 may comprise computing devices that access and use the resources of the virtualized computing platform 102, including the UIs 106, and may also use or implement components of the recommendation system 112. The users corresponding to the user system 120 may be end users, system administrators, product managers, developers, etc. In some embodiments, the user system 120 and the developer system 116 may be associated with the same entity (e.g., a customer of the provider that operates the provider system 108 to provide the virtualized computing platform 102), and may use or implement components of the recommendation system 112.

Other systems in the computing environment 100 may include a third-party system 122. The third-party system 122 may develop products that are pushed or otherwise provided to the virtualized computing platform 102. Such products may be hardware, software, services, applications, etc., including associated UIs that may be included amongst the UIs 106. As such, the third-party system 122 may also use or implement some components of the recommendation system 112.

UI Content Recommendation System

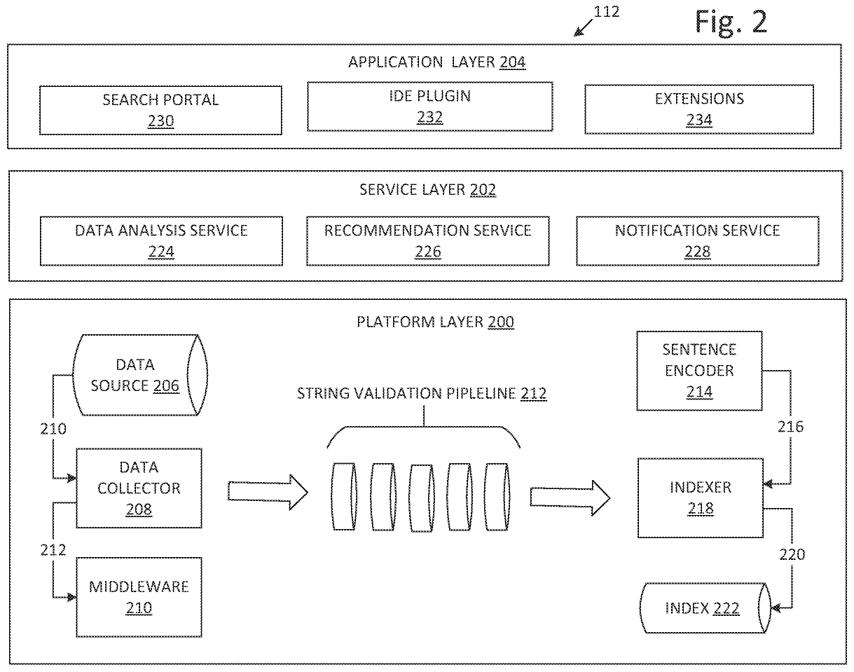

FIG. 2 is a schematic diagram illustrating an example architecture for the recommendation system 112 implemented in the computing environment 100 of FIG. 1. The recommendation system 112 of some embodiments may include a plurality of layers, such as a platform layer 200, a service layer 202, and an application layer 204 as examples. Each of these layers 200-204 may in turn include a plurality of components, which may be in the form of plug-ins, hardware and software, modular units, agents, services, engines, application program interfaces (APIs), processors, storage units or other data structures, etc. As previously explained above, at least some components of the recommendation system 112 may reside in the management server 110 and/or may reside elsewhere in the computing environment 100, including distributed components in some implementations.

Beginning first at the platform layer 200, a data source 206 may provide UI strings. For example, the data source 206 may be a repository of standardized/template UI strings. In some implementations, the data source 206 may reside in the storage unit 114 of FIG. 1, and may provide UI strings such as those available from VMware™, Inc.'s Translation Management System.

A data collector 208 connects to the data source 206 so as to collect (shown at 210) the UI strings from the data source 206. The data collector 208 then pushes (shown at 212) the UI strings to message-oriented middleware 214. The middleware 214 provides buffering to handle high occurrence scenarios for the UI strings, such as filtering out or otherwise identifying duplicate UI strings, etc.

Data (e.g., UI string) validation is performed by a string validation pipeline 212. Among other things, the string validation pipeline 212 can check and validate characteristics of the UI content (e.g., text) of each UI string, such as spelling, grammar, terminology, etc. This validation may be performed, for example, to ensure that the UI strings meet quality standards, and may be performed prior to such UI strings being indexed and used as validators for other/subsequent UI strings.

According to various embodiments, components of the string validation pipeline 212 may be pluggable (e.g., embodied as plugins). Further, the string validation pipeline 212 may be configurable and customizable so as to meet certain requirements/standards or use/implementation scenarios of the customer or other user/entity.

After validation by the string validation pipeline 212, encoding and indexing may be performed on the UI strings. A sentence encoder 214 may be configured to encode (shown at 216) the UI strings, for example using sentence embedding techniques in which text is encoded into a numerical format or other type of format that can be indexed/stored by an indexer 218 and consumed by computing devices.

The indexer 218 may be, for example, an Apache™ Lucene™ indexer that creates (shown at 220) an inverted index that includes sentence embeddings and validation results, which are stored/maintained in an index 222 (e.g., a Lucene™ index). The index 222 may reside in the storage unit 114 of FIG. 1, so as to provide a pool of validated UI strings. According to various embodiments, the sentence encoder 214 may be configured to obtain the semantic information of the UI strings, which may be included in a Lucene™ document, and the indexer 218 may be configured to create and manage the Lucene™ index based on the Lucene™ document, with the Lucene™ index storing a list of occurrences of each atomic search criterion (e.g., text or keywords for UI strings).

With regards to the service layer 202, each product's UI string quality information can be obtained by a data analysis service 224 for different periods and release cycles of products. For example, the data analysis service 224 may be configured to obtain the UI string quality information through the UI string verification process performed by the string validation pipeline 212. The UI string quality information may cover all checkpoints, such that the data analysis service 224 may determine the overall situation of the UI string quality after data aggregation is performed by the data collector 208.

The service layer 202 may include a recommendation service, such as a semantic-based recommendation service 226. As will be explained in further detail later below, the recommendation service 226 may be configured to provide a UI string recommendation to a user based on the UI string input/query provided by the user to the recommendation system 112.

The service layer 202 may also include a notification service 228. According to various embodiments, the notification service 228 may be configured to provide UI string verification results/reports for a specific product to users that have subscribed to the recommendation system 112. In some embodiments, the notification service 228 may also provide UI string recommendations in response to user queries, alternatively or in addition to the recommendation service 226 providing the recommendations.

At the application layer 204, a search portal 230 may be configured to provide a UI or other tool(s) to enable a user to enter a search query for a UI string. For example, if the user is creating a welcome page for an application's UI, the user may provide the keywords “welcome” or “hello” in a search query that is entered via a search UI of the search portal 230. The recommendation system 112 can in turn initiate a search for relevant UI strings that have been validated and indexed as explained above.

The search portal 230 may provide other features/functionality. For instance, the search portal 230 may provide UI(s) that display UI search query results, UI string verification results, dashboard information, etc.

An integrated development environment (IDE) plugin 232 may be configured to assist a user (e.g., a developer) in developing a new UI string, alternatively or in addition to the functionality/features provided by the search portal 230. For instance, the IDE plugin 232 may provide auto-complete capability when the developer is submitting a UI string query for processing by the recommendation service 226. In this manner, the developer may input a few keywords of the UI string, and the IDE plugin 232 may perform an auto-complete by adding additional words to the query based on the context.

The search portal 230 may also provide extensions 234. Examples of such extensions 234 may be restful APIs that are provided to users to enable the users to customize applications (and related UIs) according to their business requirements.

Collection, Validation, and Index and Search

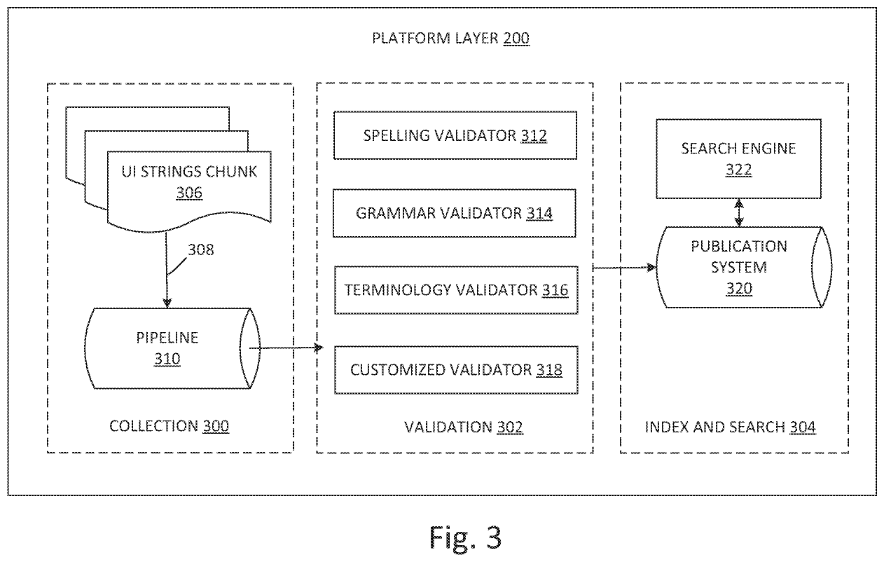

FIG. 3 is a schematic diagram illustrating example collection, validation, and index and search features for the recommendation system 112 of FIG. 2. More specifically, FIG. 3 shows additional details of at least some of the components and related functionality pertaining to a collection feature 300, a validation feature 302, and an index and search feature 304 of the platform layer 200.

For the sake of explanation, the various components and related functionality of FIG. 3 will be described herein in the context of being implemented using Apache™ Kafka™, Apache™ Lucene™, Apache™ Flink™, and Elasticsearch™. It is understood that these products are merely for purposes of illustration and explanation, and that various other embodiments may use other products/techniques/components for the collection feature 300, validation feature 302, and index and search feature 304.

Beginning first with the collection feature 300, the collected/aggregated UI strings (see, e.g., 206-212 in FIG. 2) are used to generate one or more chunks 306 each containing multiple UI strings. An Elasticsearch™ document, corresponding to a chunk 306 containing multiple UI strings, is pushed (shown at 308) to a specific Kafka™ topic, in a format such as Javascript™ object notation (JSON). A pipeline 310 (e.g., a Kafka™ pipeline) may then provide the UI strings to the validation feature 302.

The validation feature 302 may be implemented using a processing and analytics framework, such as by using the process function of Apache™ Flink™, or any other framework that provides a high-throughput, low-latency streaming engine as well as support for event-time processing and state management. Among other things, the processing and analytics framework of the validation feature 302 can provide a spelling validator 312, a grammar validator 314, a terminology validator 316, or some other validator(s) such as a customized validator 318. Using these validators 312-318, the processing and analytics framework can consume the Kafka™ topic and verify the UI strings in the chunk 306.

The validation feature 302 may then provide the validated UI strings to the index and search feature 304, specifically the validated UI strings are provided to a publication system 320. The publication system 320 may index the UI strings in the index 222. This indexing may involve, for example, publishing the validated UI strings to another Kafka™ topic and consuming the topic to create the index 222.

The index and search feature 304 may further include a search engine 322 that accesses the publication system 320 so as to perform UI string searches against the index 222. Elasticsearch™ is one example implementation of the search engine 322, and any other search engine may be used that has capability to perform vector searching (e.g., searching an index for sentence embeddings).

According to various embodiments, the search engine 322 and/or other component in the index and search feature 304 may include one or more sentence encoders (e.g., the sentence encoder 214 of FIG. 2). Such sentence encoder(s) may be configured to transform an input query having a UI string (e.g., a text string) received by the search engine 322, as well as candidate UI strings in a corpus, into sentence embeddings (e.g., vectors). To resolve the input query, the sentence embeddings of the UI strings in the input query may be compared against the sentence embeddings of the validated UI strings so as to identify the relevant candidate UI strings. Techniques for resolving input queries are described next below.

Resolving Input Queries

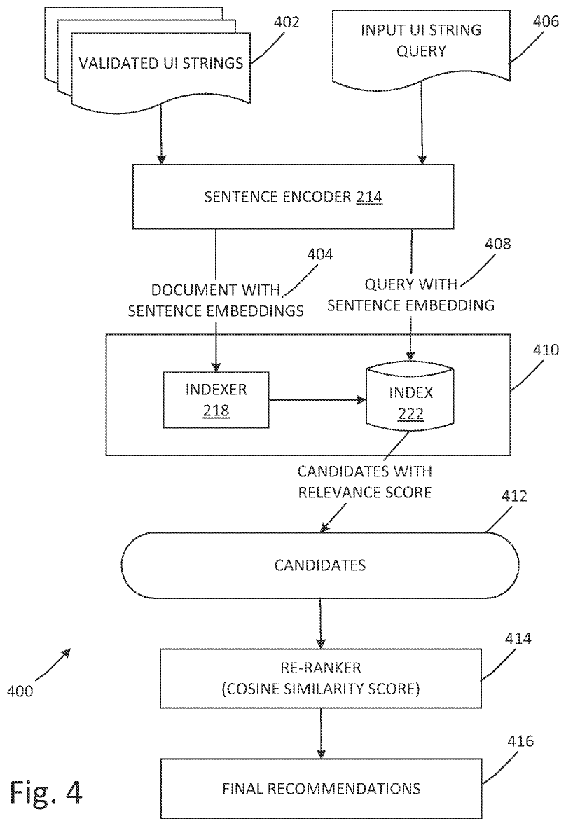

FIG. 4 is a flow diagram of an example method 400 to resolve input UI string queries. Example method 400 may include one or more operations, functions, or actions as illustrated in FIG. 4. The various operations of the method 400 and/or of any other process(es) described herein may be combined into fewer operations, divided into additional operations, supplemented with further operations, and/or eliminated based upon the desired implementation. In one embodiment, the operations of the method 400 and/or of any other process(es) described herein may be performed in a pipelined sequential manner. In other embodiments, some operations may be performed out-of-order, in parallel, etc. According to one embodiment, the method 400 may be performed by one or more computing devices that implement the platform layer 200 and the service layer 202 (shown in FIGS. 2 and 3) and/or by other component(s) of the recommendation system 112.

After the UI string verification/validation process (described above with respect to FIG. 3), each validated UI string 402 is run through the sentence encoder 214 to produce a numeric vector (e.g., one or more sentence embeddings 404 contained in a document). These sentence embeddings 404 are indexed by the indexer 218 into the index 222, in the manner described above with respect to FIGS. 2 and 3.

Analogously, when the user enters in input UI string query 406 (such as via the search portal 230), the UI string in the query 406 is also run through the sentence encoder 214 so as to produce a sentence embedding at 408.

At 410, the search engine 322 (implementing search techniques supported by Apache™ Lucene™'s BM25 or Elasticsearch™) compares the sentence embedding 408 of the query 406 against the sentence embeddings 404 of the validated UI strings 402 that are indexed in the index 222. The search engine 322 then retrieves a list of candidates (e.g., validated UI strings) that most closely match the sentence embedding 408 of the query 406.

For example, the retrieved candidates (shown at 412) may be recommended UI string candidates that meet a threshold relevance score. Any number of recommendation candidates may be retrieved by the search engine 322, for example 100 recommendation candidates.

At 414, a re-ranker function (which may be part of the search engine 322) performs a ranking/re-ranking of the retrieved candidates. According to various embodiments, the re-ranking may involve calculating a cosine similarity score between the sentence embedding 408 of the query 406 and the sentence embeddings of the UI string candidates. The cosine similarity score (or other vector similarity score) provides a measure of semantic similarity between the input query UI string and the candidate UI string.

A final recommendation 416 (e.g., from the recommendation service 226 and/or the search engine 322) is then generated. A linear combination of the relevance score from the BM25 calculation (from 410 and 412 above) and the semantic similarity score (from 414 above) may be executed by summing these scores, and a weight (such as 0.5) may be applied, so as to generate the final recommendations 416.

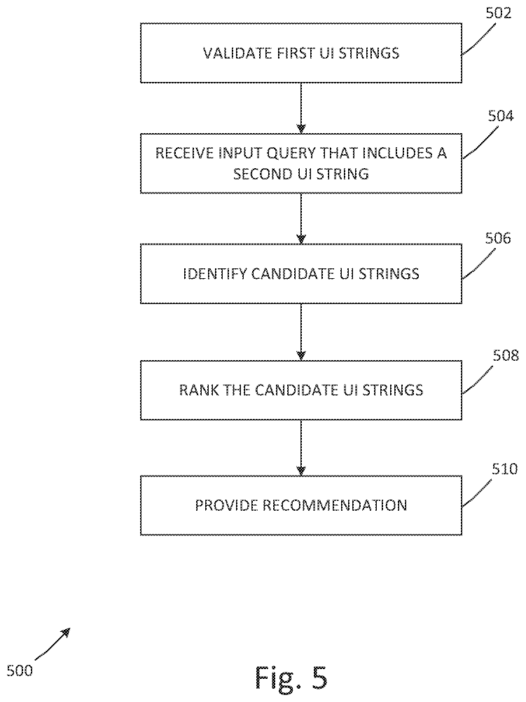

Turning now to FIG. 5, FIG. 5 is a flowchart of an example method 500 to reuse UI strings based on semantic information, wherein the method 500 integrates the operations described above with respect to FIG. 4 and the other previous figures. The method 500 may be performed by one or more computing devices that implement the platform layer 200 and the service layer 202 (shown in FIGS. 2 and 3) and/or by other component(s) of the recommendation system 112.

At 502 (“VALIDATE FIRST UI STRINGS”), first UI strings (e.g., template UI strings) have been collected by the data collector 208 using the collection feature 300, and are validated in the validation pipeline 212 by the validation feature 302. As previously explained above, this validation may involve validating spelling, grammar, terminology, etc. Furthermore, UI string quality can be improved and monitored by keeping language styles consistent and by leveraging translation resources. The validated first UI strings are indexed as described above.

At 504 (“RECEIVE INPUT QUERY THAT INCLUDES A SECOND UI STRING”), an input query having a second UI string is received from a user that has inputted the query via the search portal 230. The second UI string may contain a full or partial set of keywords. If a partial set of keywords is provided, an auto-complete operation may be performed to complete the second UI string in the query.

At 506 (“IDENTIFY CANDIDATE UI STRINGS”), the search engine 322 compares the second UI string in the input query with the validated first UI strings to identify candidate UI strings that most closely match or correspond to the second UI string. For example, the candidate UI strings may be determined from the validated (and indexed) first UI strings using BM25 based on relevancy score(s).

At 508 (“RANK THE CANDIDATE UI STRINGS”), the search engine 322 ranks the candidate UI strings based on semantic similarity score(s), such as in the manner described above with respect to FIG. 4 using a cosine similarity metric or other vector similarity metric representative of semantic similarity.

At 510 (“PROVIDE RECOMMENDATION”), the search engine 322 and/or the recommendation service 226 provides the ranked candidate UI strings as a recommendation. For example, each of the ranked candidate UI strings may be recommended to use as the second UI string for the UI content in a user interface.

Thus, the embodiments of the recommendation system 112 disclosed herein provide UI string processing, analysis, and reuse solutions to improve the quality of UI content, and reduces costs by reusing existing UI strings. Furthermore, continuous monitoring ensures the quality of the UI strings. Still further, semantic similarity is considered when resolving input queries, so that query results are closer to user requirements. The recommendation system 112 may be configured with a plugin architecture so that components used in the validation pipeline 212, sentence encoder 214, etc. are replaceable and extendible.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-5. For example, computing devices capable of implementing the above-described functionality of the recommendation system 112 may be provided.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances (VCIs) may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method to reuse user interface (UI) strings based on semantic information, the method comprising:
validating first UI strings, wherein the first UI strings each include a text string, and wherein validating the first UI strings includes validating one or more of spelling or grammar in the text string;
receiving an input query that includes a second UI string;
comparing the second UI string with the validated first UI strings to identify candidate UI strings that correspond to the second UI string, wherein the candidate UI strings are determined based on at least one relevance score;
ranking the candidate UI strings based on at least one semantic similarity score; and
providing the ranked candidate UI strings as a recommendation for the second UI string for UI content in a user interface.

2. The method of claim 1, wherein the user interface is implemented in a virtualized computing platform.

3. The method of claim 1, wherein validating the first UI strings further includes validating one or more of terminology or customization in the text string.

4. The method of claim 1, wherein ranking the candidate UI strings includes:
determining a cosine similarity between an embedding corresponding to the second UI string and embeddings corresponding to each of the first UI strings, wherein the cosine similarity represents the at least one semantic similarity score; and
executing a linear combination of the at least one semantic similarity score and the at least one relevance score by summing the at least one semantic similarity score and the at least one relevance score.

5. The method of claim 1, further comprising:
collecting the first UI strings from a repository of template UI strings, wherein the first UI strings are validated after collection;
indexing the validated first UI strings into a pool of UI strings; and
self-adapting the pool of UI strings over time.

6. The method of claim 1, further comprising:
repeatedly validating the first UI strings;
generating statistics and reports from the repeated validation of the first UI strings; and
providing a subscription service to the statistics and reports to at least one computing device of a user to enable the user to operate the computing device to make modifications to the first UI strings based on the statistics and reports.

7. The method of claim 1, wherein receiving the input query that includes the second UI string includes receiving first keywords of the second UI string, and wherein the method further comprises performing an auto-complete to provide second keywords to the input query based on context.

8. A non-transitory computer-readable medium having instructions stored thereon, which in response to execution by one or more processors, cause the one or more processors to perform a method to reuse user interface (UI) strings based on semantic information, wherein the method comprises:
validating first UI strings, wherein the first UI strings each include a text string, and wherein validating the first UI strings includes validating one or more of spelling or grammar in the text string;
receiving an input query that includes a second UI string;
comparing the second UI string with the validated first UI strings to identify candidate UI strings that correspond to the second UI string, wherein the candidate UI strings are determined based on at least one relevance score;
ranking the candidate UI strings based on at least one semantic similarity score; and
providing the ranked candidate UI strings as a recommendation for the second UI string for UI content in a user interface.

9. The non-transitory computer-readable medium of claim 8, wherein the user interface is implemented in a virtualized computing platform.

10. The non-transitory computer-readable medium of claim 8, wherein validating the first UI strings further includes validating one or more of terminology or customization in the text string.

11. The non-transitory computer-readable medium of claim 8, wherein ranking the candidate UI strings includes:
determining a cosine similarity between an embedding corresponding to the second UI string and embeddings corresponding to each of the first UI strings, wherein the cosine similarity represents the at least one semantic similarity score; and
executing a linear combination of the at least one semantic similarity score and the at least one relevance score by summing the at least one semantic similarity score and the at least one relevance score.

12. The non-transitory computer-readable medium of claim 8, wherein the method further comprises:
collecting the first UI strings from a repository of template UI strings, wherein the first UI strings are validated after collection;
indexing the validated first UI strings into a pool of UI strings; and
self-adapting the pool of UI strings over time.

13. The non-transitory computer-readable medium of claim 8, wherein the method further comprises:
repeatedly validating the first UI strings;
generating statistics and reports from the repeated validation of the first UI strings; and
providing a subscription service to the statistics and reports to at least one computing device of a user to enable the user to operate the computing device to make modifications to the first UI strings based on the statistics and reports.

14. The non-transitory computer-readable medium of claim 8, wherein receiving the input query that includes the second UI string includes receiving first keywords of the second UI string, and wherein the method further comprises performing an auto-complete to provide second keywords to the input query based on context.

15. A computing device, comprising:
a processor; and
a non-transitory computer-readable medium coupled to the processor and having instructions stored thereon, which in response to execution by the processor, cause the processor to perform operations to reuse user interface (UI) strings based on semantic information, wherein the operations comprise:
validate first UI strings, wherein the first UI strings each include a text string, and wherein validation of the first UI strings includes validation of one or more of spelling or grammar in the text string;
receive an input query that includes a second UI string;
compare the second UI string with the validated first UI strings to identify candidate UI strings that correspond to the second UI string, wherein the candidate UI strings are determined based on at least one relevance score;
rank the candidate UI strings based on at least one semantic similarity score; and
provide the ranked candidate UI strings as a recommendation for the second UI string for UI content in a user interface.

16. The system of claim 15, wherein the user interface is implemented in a virtualized computing platform.

17. The system of claim 15, wherein validating the first UI strings includes validating one or more of terminology or customization in the first UI strings.

18. The system of claim 15, wherein the operations to rank the candidate UI strings includes operations to:
determine a cosine similarity between an embedding corresponding to the second UI string and embeddings corresponding to each of the first UI strings, wherein the cosine similarity represents the at least one semantic similarity score; and
execute a linear combination of the at least one semantic similarity score and the at least one relevance score by summing the at least one semantic similarity score and the at least one relevance score.

19. The system of claim 15, wherein the operations further comprise:
collect the first UI strings from a repository of template UI strings, wherein the first UI strings are validated after collection;
index the validated first UI strings into a pool of UI strings; and
self-adapt the pool of UI strings over time.

20. The system of claim 15, wherein the operations further comprise:
repeatedly validate the first UI strings;
generate statistics and reports from the repeated validation of the first UI strings; and
provide a subscription service to the statistics and reports to at least one computing device of a user to enable the user to operate the computing device to make modifications to the first UI strings based on the statistics and reports.

21. The system of claim 15, wherein the operations to receive the input query that includes the second UI string includes operations to receive first keywords of the second UI string, and wherein the operations further comprise: perform an auto-complete to provide second keywords to the input query based on context.
